(19) United States
(12) Patent Application Publication
(10) Pub. No.: US 2005/0201559 A1
(43) Pub. Date: Sep. 15, 2005

(54) Conditional access system

(76) Inventor: Gerardus Wilhelmus Theodorus Van Der Heijden, Eindoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/514,591

(22) PCT Filed: Apr. 23, 2003
(86) PCT No.: PCT/IB03/01713

§ 371 Date: Nov. 16, 2004

(30) Foreign Application Priority Data
May 21, 2002 (EP) 02076984.0

(51) Int. Cl. H04N 7/167

(52) U.S. Cl. 380/239

(57) ABSTRACT

A broadcast receiver includes a tuner/de-multiplexer 410, 420 for selectively tuning into at least one of a plurality of broadcast digital transport streams, and de-multiplex the tuned transport stream into a plurality of parallel de-multiplexed data streams in order to selectively provide at least one of de-multiplexed data streams. A de-multiplexed data stream 5 may be scrambled under control of a time-varying content key. The tuner/de-multiplexer extracts from the tuned transport stream for at least two scrambled de-multiplexed data streams a respective control word stream 510, 520, 530. Each control word represents an encrypted content key. A controller supplies control words 550 from the control word streams to the decryptor 450,560. The decryptor decrypts the control words and supplies the 10 corresponding content keys to the controller. The controller forms for each control word stream a corresponding content key stream 570, 580, 590 and stores for each content key stream at least a latest content key in a memory. The controller provides for a selected de-multiplexed data stream the corresponding content keys from the memory to a de scrambler to enable the de scrambler to descramble the data stream.

### FIELD OF THE INVENTION

The invention relates to a conditional access system, in particular a broadcast receiver for providing conditional access to broadcast data, such as digital audio/video data.

### BACKGROUND OF THE INVENTION

Increasingly digital audio/video transmission systems are used for broadcasting audio/video channels. Taking the DVB (Digital Video Broadcasting) system as an example, a network provider broadcasts a number of transport streams, each containing a number of services. Usually, the transport streams are transmitted in distinct frequency bands (frequency multiplexing), whereas the services are coded into the stream using time multiplexing. A service is usually referred to as a channel. A receiver includes a tuner for tuning to a specific transport stream and a de-multiplexer for extracting a specific service/channel from the stream. In DVB, the A/V streams are MPEG-2 coded. The transport stream is a multiplex of MPEG-2 coded data streams. In the receiver, a data stream extracted by the de-multiplexer is MPEG-2 decoded to a suitable form for rendering, for example in an analogue form for presentation on a display. In certain receivers two sets of tuner/de-multiplexers/decoders are used to enable a user to view one channel, while a different channel is being recorded simultaneously.

In a conventional broadcast system, data is broadcast by a transmitter to a plurality of receivers. Access to the data can be made conditional, for instance depending on whether or not a subscription fee has been paid for a specific receiver. Such conditional access to the data services is realized by scrambling (encrypting) the data under control of an authorization key and by transmitting the scrambled data to the receivers. Typically, the scrambling occurs in the transmitter. The decryption keys necessary for the descrambling (decryption) of the data are encrypted themselves and transmitted to the receivers. Usually, symmetrical encryption techniques are used, where the encryption and decryption keys are the same. Only those receivers that are entitled to the data are able to decrypt the decryption key using a decryptor. The receivers can then descramble the data using a descrambler for decrypting the data. The descrambler decrypts the data blocks under control of the same authorization key as used for the encryption. Normally the encryption/decryption of the authorization key occurs in a secure environment. To this end, these functions are usually executed on a smart-card in or connected to the receiver. The authorization key may be used to directly control the encryption/decryption of the data stream. It is however preferred to add one or more security layers to ensure that a malicious user does not retrieve the authorization key sent from the decryptor to the descrambler and supplies the key to descramblers of other receivers. In such systems, the key used for scrambling/descrambling the data is changed frequently (e.g. once every 10 seconds). This key is usually referred to as the content key. The content key itself is also transmitted (usually broadcast) to all receivers in an encrypted form (referred to as control word), using the authorization key to control the encryption. In this scenario, the authorization key directly controls the decryption of the control word, and indirectly the descrambling of the data. The decryption of the control word also takes place in the secure module of the receiver. Decryption of a control word takes a considerable amount of time, for example 300 to 600 msecs. Conventional broadcast receivers are designed to deal with one scrambled stream.

### SUMMARY OF THE INVENTION

It is an object of the invention to provide a broadcast receiver better suited for dealing with multiple scrambled streams.

To meet the object of the invention, the broadcast receiver for providing conditional access to broadcast data streams, includes at least one tuner/de-multiplexer; at least one descrambler and at least one decryptor; the tuner/de-multiplexer being operative to selectively tune into at least one of a plurality of broadcast digital transport streams, de-multiplex the tuned transport stream into a plurality of parallel de-multiplexed data streams in order to selectively provide at least one of de-multiplexed data streams, where a de-multiplexed data stream may be scrambled under control of a time-varying content key, extract from the tuned transport stream for at least two scrambled de-multiplexed data streams a respective control word stream, where each control word represents an encrypted content key, and provide the control word streams; the decryptor being operative to decrypt a control word into a corresponding content key; the broadcast receiver further including a controller operative to receive from the tuner/de-multiplexer the plurality of control word streams; supply control words of the control word streams to the decryptor; retrieve for each of the supplied control words a corresponding content key from the decryptor; form for each control word stream a corresponding content key stream; store for each content key stream at least a latest content key in the memory; and for a selected de-multiplexed data stream provide the content key associated with the selected de-multiplexed data stream from the memory to the descrambler to enable the descrambler to the descramble the data stream; and the descrambler being operative to descramble a selected de-multiplexed data stream under control of content keys of the corresponding content key stream.

According to the invention, the de-multiplexer supplies for more than one data stream the corresponding control word streams. The decryptor is used to decrypt the control words for the different streams into content keys. For each stream at least one recent content key is stored in a memory. In this way the receiver has content keys ready for more than one data stream, enabling fast descrambling because the actual descrambling process of such a stream can start more quickly.

As described in the dependent claim 2, more than one data stream can be selected as output to be rendered (e.g. viewed or stored for subsequent viewing), where for all selected streams the already prepared content keys are supplied to the descrambler. In this way multiple streams can be descrambled in parallel.

In a preferred embodiment as described in the dependent claim 3, the descrambler performs the parallel descrambling in a time-multiplexed manner. Each time, the descrambler starts processing a ‘time-slice’ of data of a new data stream the content key for that stream is loaded.

As described in the dependent claim 4, a prediction is made of a channel the viewer might want to select next (e.g. a channel one higher than the current one). For the predicted channel(s), the de-multiplexer already supplies the stream of control words, and the latest decrypted control word (content key) is stored. At the moment the user then actually selects the predicted channel, the content key can be supplied ‘immediately’ to the descrambler to enable very fast access to the channel by the user.

As described in the dependent claim 5, the controller of the receiver manages the usage of the decryptor for the various control word streams. It ensures that decryption of a control word for one of the streams is not interrupted by a request for decryption of a control word for another stream. Where in principle all de-multiplexed data stream and their respective control word stream are asynchronous, in this way access to the decryptor is synchronized.

As described in the dependent claim 6, priority is given to control word streams that are newly received by the controller. For example, if a new channel is selected by the user, the controller may predict another channel as the most likely next candidate to be selected by the user. It can then instruct the de-multiplexer to supply control word for the predicted channel. By decrypting the first control word of the new control word stream with priority, the content key for descrambling the predicted channel will be available as soon as possible. In this way faster zapping by the user is enabled.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a digital broadcast system wherein the invention can be used;

FIG. 2 shows a block diagram of a broadcast receiver for use in the system;

FIG. 3 shows an exemplary use of control word and content keys;

FIG. 4 provides details of processing structure of the broadcast receiver; and

FIG. 5 shows the flow and storage of control words and content keys.

### DETAILED DESCRIPTION OF THE PREFERRED EMBODIMENT

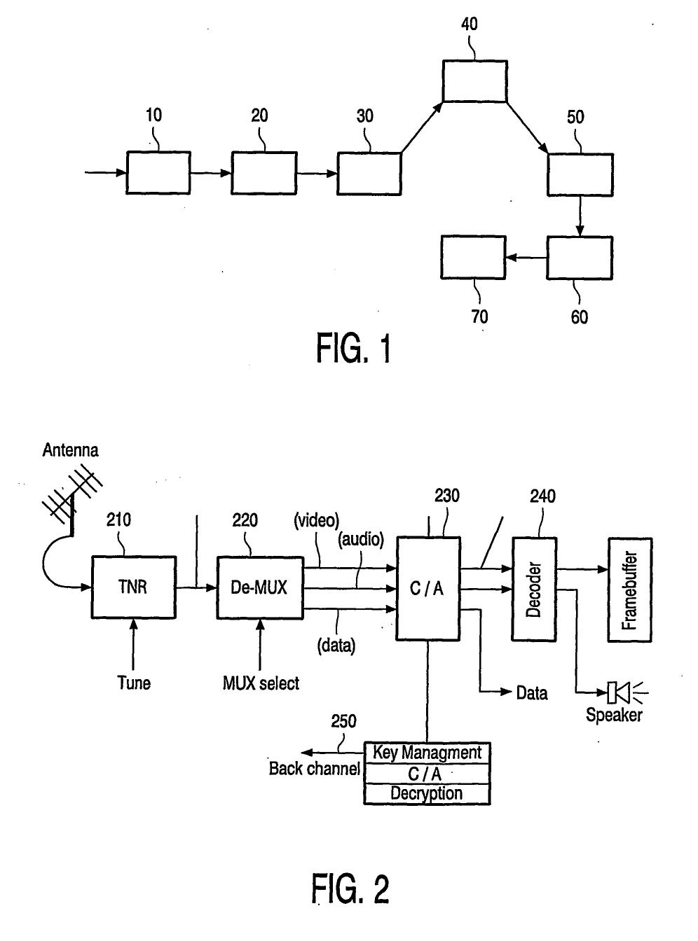

FIG. 1 gives an overview of a digital television system in which the receiver according to the invention can be used. As an example, a system is described wherein the audio/video (A/V) signals are distributed digitally using MPEG-2 compression to compress the A/V signals. The system includes an MPEG-2 compressor 10, usually located in a broadcast centre. The compressor receives a digital signal stream (typically a stream of digitized analog or digital video signals). The original signals are supplied by a service provider. The compressor is connected to a scrambler and multiplexer 20. The scrambler scrambles the digital signals of a data stream by encrypting them under control of a content key, as will be described in more detail below. The multiplexer 20 may receive in addition to one or more scrambled or non-scrambled data stream also further digital signals. The multiplexer 20 assembles all the signal and streams into a transport stream and supplies the compressed and multiplexed signals to a transmitter 30 of the broadcast centre. The scrambling and multiplexing functions may be performed in separate units, and if desired at different locations. The multiplexed transport stream may be supplied from the scrambler/multiplexer 20 to the transmitter 30 using any suitable form of linkage, including telecommunication links. The transmitter 30 transmits electromagnetic signals via an uplink towards a satellite transponder 40, where they are electronically processed and broadcast via a downlink to an earth-based satellite receiver 50, conventionally in the form of a dish of the end user. In the figure, the satellite receiver 50 is connected to an integrated receiver 60. The operation of the receiver 60 is described in more detail below with reference to FIG. 2. The receiver selects the desired signal and presents it in a suitable form to a rendering device, such as a television 70. Of course, the signal may also be recorded using a tape, optical disc or hard disk recorder or other suitable recorder. The signal may be supplied to the rendering/recording device in an analog or digital form using well-known distribution systems such as CATV cable, or IEEE 1394. For digital distribution only partial decoding of the transport stream is required, where the de-multiplexed signals are supplied in the MPEG-2 coding using partial transport streams.

It will be understood that the main distribution does not need to take place via satellite. Instead other delivery systems (i.e. the physical medium by which one or more multiplexes are transmitted) may be used, such as terrestrial broadcast, cable transmission, combined satellite/cable. The party that distributes the program via the delivery system is sometimes referred as the network provider. It will also be understood that the receiver/decoder 60 may be integrated into the rendering or recording device.

A typical system operates as a multi-channel system, implying that the multiplexer 20 can handle A/V information received from a number of (parallel) sources and interacts with the transmitter 30 to broadcast the information along a corresponding number of channels or multiplexed into separate transport streams. In addition to A/V signals, messages or applications or any other sort of digital data may be introduced in some or all of these services/channels interlaced with the transmitted digital audio and video information. As such a transport stream includes one or more services, each with one or more service components. A service component is a mono-media element. Examples of service components are a video elementary stream, an audio elementary stream, a Java application (Xlet), or other data type. A transport stream is formed by time-multiplexing one or more elementary streams and/or data.

FIG. 2 shows more details of a typical broadcast receiver. The broadcast receiver includes a tuner 210. The tuner 210 extracts a separate tunable Radio Frequency (RF) band usually resulting in an MPEG2 transport stream. Variable data signals are separated from the constant carrier signal by the de-multiplexer 220 (De-MUX). The results often are audio, video and data outputs. The video and audio streams may be fed through a Conditional Access subsystem 230, which determines access grants and may decrypt data The decrypted audio and video streams are fed to a decoder 240, which converts them into signals appropriate for the video and audio rendering or storage devices. This may involve MPEG2 decoding. A back channel 250 may, but need not be present. If it exists, data is transmitted to a server of a service provider, facilitating interactive applications such as interactive video, e-commerce and so on.

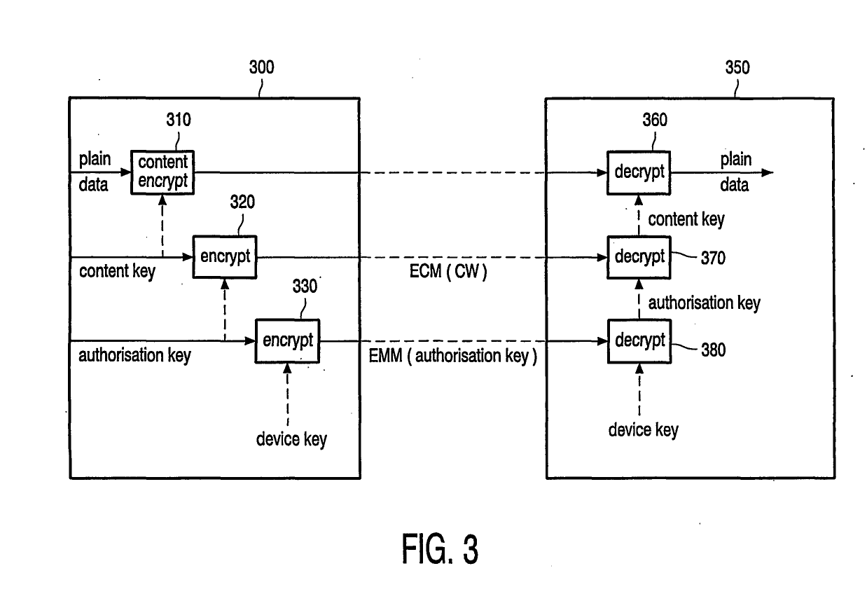

In such a broadcast system as described above, it may be desirable that only a limited number of the users of the receivers, e.g. only those who have paid or who belong to a certain group, have access to some or all data services. Such conditional access to the data services is realized by encrypting the data and by letting the transmitter 30 of FIG. 1 transmit the encrypted data to the receivers. The data may be encrypted in the transmitting system using a scrambling system 20 as shown in FIG. 1 and decrypted using the conditional access subsystem 230 of FIG. 2. More details of a typical scrambling system are shown in FIG. 3. Herein, the data is encrypted in the transmitting subsystem 300 using a content encryptor 310. Such an encryptor 310 is usually referred as scrambler. If desired, also encrypted data may be supplied to the transmitting subsystem, where the actual scrambling has taken place earlier. The data is encrypted under direct control of a content key. In a typical system, the content key changes frequently, e.g. once every 10 seconds. The content key is supplied by the transmitter to the receivers in an encrypted form, encrypted under control -of an authorization key. To this end, the transmitting subsystem includes an encryptor 320 to encrypt the content key. The encrypted content key is referred to as control word (CW). The control word is usually transmitted in a so-called Entitlement Control Message or ECM. Such an ECM may be embedded in an IP packet or an MPEG transport stream. The same ECM is sent (broadcast) to all receivers. The conditional access (CA) subsystem 350 of the receiver includes a decryptor 370 for decrypting the encrypted control word and the CA subsystem 350 retrieves the content key. The CA subsystem uses the content key for controlling decryption of the encrypted data as performed by the decryptor 360. The decryptor 360 is usually referred to as descrambler. For the purpose of security, the control word changes often, e.g. after a certain period of tine or after the transmission of a certain amount of data. A new ECM has to be transferred to the receiver, each time the control word value has changed. So with each conditionally accessible data service a stream of ECMs is associated. It may be required to retransmit an unchanged ECM several times in order to reduce the time it takes for a receiver to access the service. (To access a service, the receiver must first acquire the corresponding ECM.). For the invention it is irrelevant how many security layers are used. The invention deals with processing of multiple control word streams, where the associated decrypted content keys are supplied to a descrambler. The exact relationship between a control word (e.g. via one or more intermediate encryption layers) does not affect the invention. Persons skilled in the art will be able to apply the invention also in system with different security layers. It will also be appreciated that the system is described using MPEG coding and an architecture like DVB as an example. The invention can also be exploited in other systems where multiple scrambled streams are transmitted in a multiplexed form.

For such schemes to work, the receiver needs to obtain secure access to the authorization key. To this end, typically each device is associated with one fixed device key, usually incorporated in a smart card. The transmitter has access to all fixed device keys. For each device, the transmitter retrieves its associated fixed device key and uses an encryptor 320 to encrypt the authorization key under control of the fixed device key. The encrypted authorization key is then transmitted to only the associated receiver, using a so-called Entitlement Management Message (EMM). This may be realized by giving each receiver a unique identifier and using this identifier as an address in the EMM. When broadcasting the EMM, each receiver receives the EMM but only the one whose identifier matches the address will receive the EMM and decrypt the authorization key. The receiver includes a decryptor 380. The decryptor 380 is used under control of the fixed device key to decrypt the received encrypted authorization key. The retrieved authorization key is then used to control the decryptor 370. In the remainder, the roles of the decryptors 370 and 380 will collectively be referred to as ‘decryptor’. The decryptor is preferably also incorporated in the smart card that holds the device key.

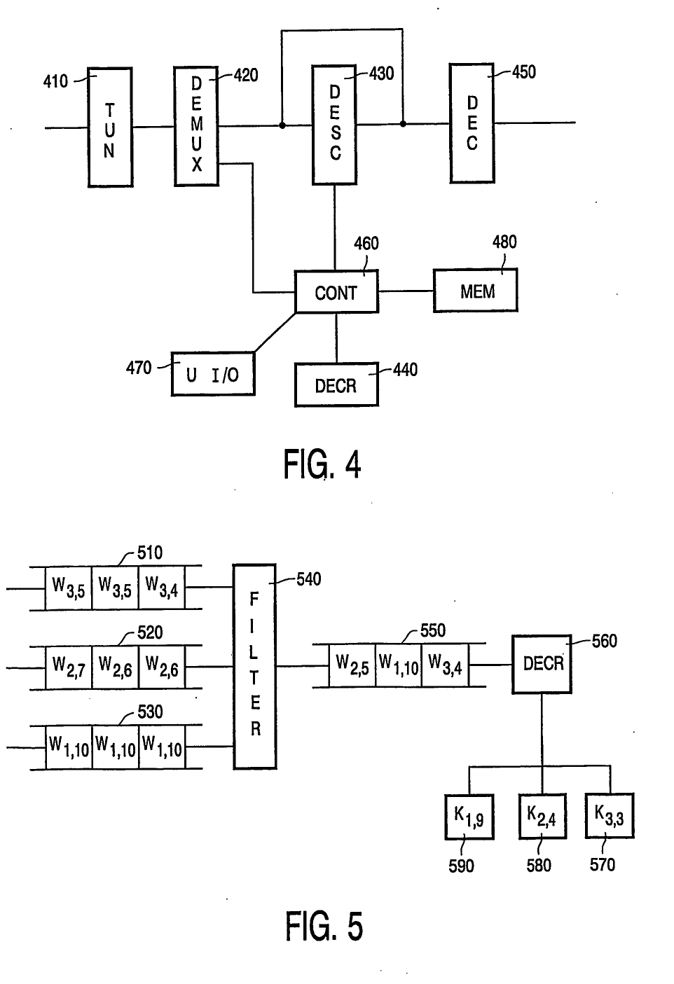

FIG. 4 provides more details of processing aspects of the broadcast receiver. The broadcast receiver includes a tuner function 410, a de-multiplexer function 420, a descrambler function 430, a decryptor function 440 and a decoder function 450. The functions may be performed using dedicated hardware. Some functions or part of the functions may also be performed by a programmable processing function, for instance using a digital signal processor (DSP) loaded with a suitable program. The descrambler and decryptor together form the core of the conditional access system. The various functions within the receiver are operated under control of a controller 460, which typically includes an embedded microprocessor or microcontroller. To keep the figure simple, the control relationships between the controller and the other functions are not shown. Only the roles that the controller can have in processing of the control words and content keys are shown. A user interface 470 enables the receiver to interact with the user. The user interface 470 may include any suitable user input means, such as an Infrared receiver for receiving signals from an IR remote control, a keyboard, or a microphone for voice control. For output, also any suitable form may be used, such as using a small LCD display or using the display of a television, or even audible feedback. During normal operation, the user selects a channel/service. Usually this is done by the user indicating a preset number using the user interface 470. Using a table with all installed channels stored in a memory 480, the preset number is translated into a form suitable for controlling the tuner 410 and de-multiplexer 420. For a digital system this may be an identification of the channel including the network_id, transport_stream_id and channel_id. Using a network information table (NT) transmitted in the digital stream, the transport_stream_id can be translated to frequency, enabling the tuner 410 to tune to the frequency multiplexed transport stream. The channel-id enables the de-multiplexer to extract the desired channel from the multiplexed stream. If the channel is scrambled it is fed through the descrambler 430 and then fed through the decoder 450. Plain streams can be supplied directly to the decoder bypassing the descrambler. Output of the decoder can be supplied to a rendering device or storage device for subsequent rendering. For certain applications, the receiver may provide encoded output streams, bypassing the decoder 450. The rendering device may then include the decoder function or the encoded stream may at a later stage be re-supplied to the receiver for further decoding. Similarly, it is in principle possible to a store a scrambled stream in a scrambled form without first descrambling the stream. The stream can then be descrambled at a later stage by feeding it through the descrambler. Since the control word stream in principle runs parallel to the data stream, in this case special care may be required for synchronizing both streams. To simplify the description, in the remainder it is assumed that the receiver fully processes a data stream in one go, although persons skilled in the art will be able to apply the principle of the invention in other situations as well.

According to the invention, the de-multiplexer supplies control word streams for at least two data streams. In practice, the de-multiplexer may then also provide all of those data streams but those data streams need not be consumed by the remainder of the receiver. If the control word streams that are supplied by the de-multiplexer are available in the same frequency-multiplexed transport stream, a tuner function may be used that only supports tuning to one transport stream. Preferably a tuning function is used that can tune to a plurality of independent transport streams. To this end, the tuner 410 may include several parallel arranged tuning units, each capable of tuning to one transport stream. Analogously, the multiplexer function 420 may be able to provide the plurality of control word streams using one set of de-multiplexing hardware/software or using multiple parallel arranged sets. The control word stream is of a relatively low frequency. For example, every 10 seconds an ECM may be supplied with a new control word for an associated data stream. EMMs are usually supplied at an even much lower rate. Since the frequency is low, the stream is usually managed by the main controller 460 of the receiver. It will be understood that no decryption and descrambling can start before a suitable control word is present in the receiver. Conventionally, a user had to first select a channel, the tuner and de-multiplexer would then be controlled to supply the channel and associated control word stream. Once a control word had been received, it needed first to be decrypted and only then descrambling could start. To reduce the latency in this conventional system in receiving the first control word, a same control word was usually broadcast repeatedly, e.g. every 10 seconds. Since of a sequence of several of the same control words only one needs to be decrypted, the controller can filter the control word streams by deleting duplicate copies. The controller feeds the filtered streams of control words to the decryptor 440. The decryptor supplies the decrypted control words (i.e. content keys) back to the controller 460. It should be noted that in principle all data streams and their corresponding control word streams may be asynchronous, in that the frequency of and instants of supply of control words is independent of each other. To deal with such asynchronous behavior, a special decryptor may be used capable of processing several independent control word streams.

In a preferred embodiment, use is made of a conventional decryptor designed to process only one stream of control words in the sense that the controller supplies a control word to the decryptor, the decryptor decrypts the control word (in, for example, 300-600 msecs), and supplies the content key back. While decrypting the control word, the decryptor can not decrypt other control words, but in the conventional system where only one stream is being descrambled no such control words would normally arrive in such a period. This makes the conventional decryptor as such unsuitable for processing multiple asynchronous control word streams. According to the invention, the controller 460 synchronizes the asynchronous control word stream and provides one multiplexed control word stream to the decryptor. This is illustrated in FIG. 5. In this figure, three independent streams 510, 520, 530 of control words are fed through a filtering function 540 of the controller 460. The output of the filter is put in one buffer 550 acting as a queue. Memory 480 of FIG. 4 may be used for storing the queue. Normally the control words are put in the queue in time sequence of arrival. The controller supplies control words from the queue to the decryptor 560 in sequence of arrival in the queue. The controller monitors whether the decryptor is still busy processing a previously supplied control word. As long as the decryptor is busy, no new word is supplied. As soon as the decryptor is free a new word can be supplied (if such a word is already present in queue). The controller ensures that the content keys supplied by the decryptor are stored in a memory. For active data streams, the content key may be immediately supplied to the descrambler or kept until the moment a trigger is given via the broadcast signals that the data arriving now has been scrambled with the next content key. Until actually used by the descrambler, the content key may be stored in a general purpose memory of the receiver. If so desired, it may already be stored in dedicated registers in the descrambler to enable faster switching. For data streams not yet processed by the descrambler, preferably the controller ensures that a content key is stored in the general memory for ‘instant’ supply to the descrambler when the data stream is selected for further processing and supplied to the descrambler. The supply of the data stream to the descrambler and the corresponding content key is then synchronized. In FIG. 5, it is shown that one content key 570, 580, 590 is stored for each of the shown control word streams 510, 520, 530.

Conventionally, for a data stream two control words are ‘active’, usually referred to as odd and even control word. While the content key corresponding to one of the control words is used for descrambling the current part of the data stream, the next control word is already being broadcast to all receivers. This enables the receivers to decrypt the second control word. Following an indication in the broadcast stream the descrambling is switched to the new key. In the receiver according to the invention, two content keys are stored for each control word stream processed by the system as described above. Persons skilled in the art will be able to adapt this for other systems, where it may be necessary to store more than two keys.

In a preferred embodiment, the stored decrypted control words are used to enable fast selection of a new channel. As an example, the user may have selected one channel for viewing (or storage). The controller estimates one or more channels the user may want to select next. The controller instructs the tuner/de-multiplexer to already supply the control word stream for the predicted channel(s). As described above, the controller ensures that for each of those predicted channels at least one content key is available. On actual selection of a new channel, the corresponding data stream can then be supplied to the descrambler and the content key supplied, without first having to wait for receipt of a control word for the newly selected stream and having to decrypt the control word. While normally the control words may be put in the queue 550 in time sequence of arrival, whenever the user selects a new channel it may be preferred to give priority to control words of a new stream. For example, if the user selects channel 10 then a content key for this channel should be ready if this channel had been predicted correctly. The new predicted channel may become channel 11. In this case, the controller ensures that control words for channels 11 are supplied by the de-multiplexer. If the available content keys still have sufficient life time left, the controller preferably provides the first received control word for channel 11 to the decryptor as soon as the decryptor is available. This can be done by inserting the control word at the location to be output next to the decryptor.

Preferably, for each predicted stream also important packets may be filtered out to reduce delay in decoding as well. For example, for decoding of an MPEG coded stream, decoding of a frame requires at least the presence of an I-frame (intra-frame coded). By storing one or more frames, the latency in decoding can be decreased.

Prediction of a channel may be done in any suitable form. For example, the prediction algorithm could be based on assuming that the viewer is performing a zapping operation. If the user is zapping upwards (i.e. preset 3 is selected after preset 2), a reasonable assumption is that the next channel will be in the same upward direction, i.e. preset 4. In this example, preset numbers refer to the numbers of the stored presets and not necessary to the numbers of the underlying channels. If the receiver has capacity to process only one additional control word stream, then the predicted preset is the next preset number in the direction of the zapping. The control word stream for the channel corresponding to that preset is then loaded. If the receiver has capacity for processing two additional control streams, the next and the previous preset may be the predicted presets, catering also for users that change zapping direction. Also more advanced algorithms may be used, for example assuming that a user predominantly zaps through presets within a certain category of programs, e.g. sport programs, news program, etc. Statistical algorithms, such as hidden Markov models, may be used to learn and predict the behavior of the user.

In another preferred embodiment, the technique according to the invention is used to ‘simultaneously’ descramble more than one data stream. Advantageously, the descrambler operates in a time-multiplexed manner, i.e. the hardware/software capable of processing one stream is operated at a higher frequency so that two or more streams can be processed. The controller then ensures that at regular intervals processing is switched between the two or more input data streams. Each time processing is switched also the content key for the new stream is loaded into the descrambler. Preferably, the de-multiplexer provides the selected data streams in a time-multiplexed manner at its output. Alternatively, the de-multiplexer may provide two or more parallel data streams at its output, each at the normal timing. In this case, preferably the controller combines the multiple output streams to one time-multiplexed stream. This can be done by in turn copying a block (e.g. corresponding to 100 msec. of signal) from one of data streams and providing it to the descrambler (or copying in into a FIFO buffer for subsequent supply to the descrambler). If this occurs for 3 parallel streams, the descrambler must be able to descramble each 100 msec. slice of data at least within ⅓*100 msec. while leaving some room for switching overhead.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in a claim. The invention can be implemented by means of hardware comprising several distinct elements, and by means of a suitably programmed computer. Where the system/device/apparatus claims enumerate several means, several of these means can be embodied by one and the same item of hardware. The computer program product may be stored/distributed on a suitable medium, such as optical storage, but may also be distributed in other forms, such as being distributed via the Internet or wireless telecommunication systems.

1. A broadcast receiver for providing conditional access to broadcast data streams, including at least one tuner/de-multiplexer; at least one descrambler and at least one decryptor;
the tuner/de-multiplexer being operative to:
selectively tune into at least one of a plurality of broadcast digital transport streams,
de-multiplex the tuned transport stream into a plurality of parallel de-multiplexed data streams in order to selectively provide at least one of de-multiplexed data streams, where a de-multiplexed data stream may be scrambled under control of a time-varying content key,
extract from the tuned transport stream for at least two scrambled de-multiplexed data streams a respective control word stream, where each control word represents an encrypted content key, and
provide the control word streams;
the decryptor being operative to decrypt a control word into a corresponding content key;
the broadcast receiver further including a controller operative to receive from the tuner/de-multiplexer the plurality of control word streams; supply control words of the control word streams to the decryptor; retrieve for each of the supplied control words a corresponding content key from the decryptor; form for each control word stream a corresponding content key stream; store for each content key stream at least a latest content key in the memory; and for a selected de-multiplexed data stream provide the content key associated with the selected de-multiplexed data stream from the memory to the descrambler to enable the descrambler to the descramble the data stream; and
the descrambler being operative to descramble a selected de-multiplexed data stream under control of content keys of the corresponding content key stream.

2. A receiver as claimed in claim 1, wherein the tuner/de-multiplexer is operative to provide a plurality of selected de-multiplexed data streams, and the descrambler is operative to descramble the plurality of de-multiplexed data streams under control of content keys supplied from the memory for each of the selected streams.

3. A receiver as claimed in claim 2, wherein the descrambler is operative to perform the descrambling of the plurality of selected de-multiplexed data streams in a time-multiplexed manner; the plurality of de-multiplexed data streams provided by the tuner/descrambler being temporarily buffered for supply as a time-multiplexed stream to the descrambler; the controller being operative to cause, synchronously with the descrambler switching to descrambling data from a different one of the selected de-multiplexed data streams, loading into the descrambler of a content key from the memory for the different one of the selected de-multiplexed data streams.

4. A receiver as claimed in claim 1, wherein the controller is operative to predict a next data stream to be supplied in descrambled form; to cause the tuner/de-multiplexer to provide a control word stream for the predicted data stream; and in response to an actual selection of the data stream, to cause supply of the newly selected data stream to the descrambler synchronous with supply of a content key stored in the memory for the data stream.

5. A receiver as claimed in claim 1, wherein the controller is operative to arrange control words of the plurality of control word streams in a sequence for sequential supply to the decryptor where a next control word of the sequence is only supplied only after the decryptor has completed decryption of a previously supplied control word.

6. A receiver as claimed in claim 5, wherein the controller is operative to give priority in the sequence to a control word of a control word stream that is newly provided.
